(19) United States
(12) Patent Application Publication
(10) Pub. No.: US 2019/0352546 A1
(43) Pub. Date: Nov. 21, 2019

(54) DIELECTRIC HEATING ADHESIVE FILM AND ADHESION METHOD USING DIELECTRIC HEATING ADHESIVE FILM

(71) Applicant: LINTEC Corporation, Tokyo (JP)

(72) Inventors: Naoki TAYA, Tokyo (JP); Masakazu ISHIKAWA, Tokyo (JP)

(21) Appl. No.: 16/484,425

(22) PCT Filed: Feb. 8, 2018
(86) PCT No.: PCT/JP2018/004306

§ 371 Date: Aug. 7, 2019

(30) Foreign Application Priority Data
Feb. 9, 2017 (JP) 2017-021803
Feb. 9, 2017 (JP) 2017-021806

(51) Int. Cl. C09J 123/08; C09J 7/35; C09J 5/06; C09J 9/02

(52) U.S. Cl. CPC C09J 123/0853; C09J 7/35; C09J 5/06; C09J 9/02; C08K 2003/2296; C09J 2205/31; C09J 2205/114; C09J 2423/04; C09J 2431/00; C09J 123/0846

(57) ABSTRACT

A dielectric welding configured to weld a plurality of adherends of the same material or different materials through dielectric heating is provided. The dielectric welding film contains an A component in a form of a thermoplastic resin and a B component in a form of a dielectric filler, the A component including a polyolefin resin having a polar part, a content of the B component in the dielectric welding film ranging from 3 volume % to 40 volume %.

### TECHNICAL FIELD

The present invention relates to a dielectric welding film, and a welding method using the dielectric welding film.

### BACKGROUND ART

In order to weld typically hard-to-bond adherends (i.e. difficult to be bonded), it has been recently proposed that, for instance, a welding process such as dielectric heating, induction heating, ultrasonic welding or laser welding is performed with an adhesive produced by blending a heat-generating material in a predetermined resin interposed between the adherends.

For instance, Patent Literatures 1 and 2 disclose adhesives having 0.03 or more dissipation factor (tan δ), which contain a polyolefin resin blended with a ferroelectric and a carbon compound and the like, and a polyolefin resin blended with a conductive material and the like, respectively. Further, Patent Literatures 1 and 2 each disclose a welding method for interposing the adhesive between a plurality of adherends and welding the plurality of adherends through a dielectric heating at a frequency of 40 MHz.

Further, for instance, Patent Literature 3 discloses an adhesive composition for dielectric welding produced by adding a dielectric heating medium to an adhesive compatible with a plurality of to-be-welded adherends (base materials). Further, Patent Literature 3 discloses that the adhesive composition for dielectric heating satisfies a formula: C×{(tan δ)/ϵ′}½≥d, where ϵ′ represents specific permittivity, tan δ represents a dissipation factor, d (mm) represents a total thickness of the base materials to be bonded, and the coefficient C is in a range from 78 to 85.

### CITATION LIST

### Patent Literature(s)

Patent Literature 1 JP 2003-238745 A

Patent Literature 2 JP 2003-193009 A

Patent Literature 3 JP 2014-37489 A

### SUMMARY OF THE INVENTION

### Problem(s) to be Solved by the Invention

The adhesives for dielectric heating disclosed in Patent Literatures 1, 2 and 3, however, require a long application time of a high-frequency wave.

An object of the invention is to provide a dielectric welding film capable of reducing the application time of a high-frequency wave and improving welding strength with a short-time application of the high-frequency wave, and a welding method using the dielectric welding film.

### Means for Solving the Problems

A dielectric welding film according to an aspect of the invention is configured to weld a plurality of adherends of the same material or different materials though dielectric heating, the dielectric welding film including: a thermoplastic resin as an A component; and a dielectric filler as a B component, where the A component comprises a polyolefin resin having a polar part, and a content of the B component in the dielectric welding film ranges from 3 volume % to 40 volume %.

In the dielectric welding film according to the above aspect of the invention, it is preferable that the B component is at least one compound selected from the group consisting of zinc oxide and barium titanate.

In the dielectric welding film according to the above aspect of the invention, it is preferable that the B component generates heat when applied with a high-frequency wave ranging from 1 kHz to 300 MHz.

In the dielectric welding film according to the above aspect of the invention, it is preferable that a mean particle size of the dielectric filler as the B component measured according to JIS Z 8819-2 (2001) is in a range from 0.1 μm to 30 μm.

In the dielectric welding film according to the above aspect of the invention, it is preferable that a constituent unit derived from olefin in the A component is derived from ethylene or propylene.

In the dielectric welding film according to the above aspect of the invention, it is preferable that the polar part is a carboxy group, or an acid anhydride moiety.

A welding method according to another aspect of the invention uses a dielectric welding film configured to weld a plurality of adherends of the same material or different materials though dielectric heating, the dielectric welding film being the dielectric welding film according to the above aspect of the invention, the method including: holding the dielectric welding film between the plurality of adherends; and applying dielectric heating on the dielectric welding film held between the plurality of adherends with a dielectric heater at a high-frequency output ranging from 0.01 to 20 kW for a high-frequency-wave application time ranging from 1 second to 40 seconds.

In the welding method using the dielectric welding film according the above aspect of the invention, it is preferable that a frequency of the high-frequency wave applied in applying the dielectric heating ranges from 1 kHz to 300 MHz.

According to the above aspects of the invention, a dielectric welding film capable of reducing the application time of a high-frequency wave and improving welding strength with a short-time application of the high-frequency wave can be provided.

### BRIEF DESCRIPTION OF DRAWING(S)

FIG. 1 illustrates dielectric heating performed with a dielectric heater.

### DESCRIPTION OF EMBODIMENT(S)

### First Exemplary Embodiment

A dielectric welding film according to a first exemplary embodiment is configured to weld a plurality of adherends of the same material or different materials through dielectric heating, the dielectric welding film containing an A component in a form of a thermoplastic resin and a B component in a form of a dielectric filler, the A component including a polyolefin resin having a polar part, a content of the B component in the dielectric welding film ranging from 3 volume % to 40 volume %.

The components, properties and the like of the dielectric welding film according to the first exemplary embodiment will be specifically described below.

### Dielectric Welding Film

### 1 Components of Dielectric Welding Film

### (1) A Component (Thermoplastic Resin)

The A component (thermoplastic resin) as an adhesive component includes a polyolefin resin having a polar part. The above polyolefin resin having a polar part will be sometimes referred to as an A1 component hereinafter.

The polar part of the polyolefin resin as the A1 component is not particularly limited as long as the polar part gives polarity to the polyolefin resin.

The A1 component may be a copolymer of an olefin monomer and a monomer having the polar part. Alternatively, the A1 component may be a resin provided by introducing the polar part through an addition reaction to an olefin polymer produced by polymerizing olefin monomers.

The type of the olefin monomers for forming the A1 component is not particularly limited. Examples of the olefin monomer include ethylene, propylene, butene, hexene, octene, and 4-methyl-1-pentene. The olefin monomer may be a single one of the above exemplary monomers, or may be a combination of two or more of the above exemplary monomers.

The olefin monomer is preferably selected from ethylene and polypropylene in terms of excellent mechanical strength and stable weldability.

A constituent unit derived from olefin in the A1 component is preferably a constituent unit derived from ethylene or propylene.

Examples of the polar part include a hydroxyl group, a carboxy group, a vinyl acetate moiety, an acid anhydride moiety, and an acid-modified moiety introduced to the polyolefin resin by acid modification.

The acid-modified moiety as the polar part is a portion introduced by acid modification of the polyolefin resin. Examples of compounds used for graft-modification of the polyolefin resin include an unsaturated carboxylic acid derivative component derived from an unsaturated carboxylic acid, an acid anhydride of an unsaturated carboxylic acid, and an unsaturated carboxylic acid ester.

Examples of the unsaturated carboxylic acid include acrylic acid, methacrylic acid, maleic acid, fumaric acid, itaconic acid, and citraconic acid.

Examples of the acid anhydride of the unsaturated carboxylic acid include maleic anhydride, itaconic anhydride, and citraconic anhydride.

Examples of the unsaturated carboxylic acid ester include methyl acrylate, ethyl acrylate, methyl methacrylate, ethyl methacrylate, butyl methacrylate, dimethyl maleate, monomethyl maleate, dimethyl fumarate, diethyl fumarate, dimethyl itaconate, diethyl itaconate, dimethyl citraconate, diethyl citraconate, and dimethyl tetrahydrophthalate anhydride.

When the polyolefin resin as the A1 component is a copolymer of the olefin monomer and the monomer having the polar part, the copolymer preferably includes 2 mass % or more, more preferably 4 mass % or more, further preferably 5 mass % or more, and especially preferably 6 mass % or more constituent unit derived from the monomer having the polar part. The copolymer preferably includes 30 mass % or less, more preferably 25 mass % or less, further preferably 20 mass % or less, and especially preferably 15 mass % or less constituent unit derived from the monomer having the polar part.

The 2 mass % or more constituent unit derived from the monomer having the polar part contained in the copolymer improves welding strength of the dielectric welding film. Further, the thermoplastic resin as the A1 component can be kept from being excessively tacky at the content of 30 mass % or less of the constituent unit derived from the monomer having the polar part in the copolymer. Consequently, the dielectric welding film can be molded without difficulty.

When the polyolefin resin as the A1 component has the acid-modified moiety, the acid-modification rate is preferably 0.01 mass % or more, more preferably 0.1 mass % or more, and further preferably 0.2 mass % or more. Further, the acid modification rate in the A1 component is preferably 30 mass % or less, more preferably 20 mass % or less, and further preferably 10 mass % or less.

The welding strength of the dielectric welding film is improved at 0.01 mass % or more of the acid modification rate when the polyolefin resin as the A1 component has the acid-modified moiety. The thermoplastic resin as the A1 component can be restrained from being excessively tacky at 30 mass % or less of the modification rate. Consequently, the dielectric welding film can be molded without difficulty.

The modification rate herein refers to a percentage of the mass of the component derived from acid to a total mass of the acid-modified polyolefin.

It is also preferable that the A1 component according to the first exemplary embodiment is a copolymer including a constituent unit derived from olefin and a constituent unit derived from vinyl acetate.

Further, the A1 component according to the first exemplary embodiment is preferably a polyolefin resin containing at least one of a carboxy group and acid anhydride moiety as the polar part. It is preferable that the acid anhydride moiety is introduced when the polyolefin resin is modified by maleic anhydride.

It is preferable that the A1 component according to the first exemplary embodiment is at least one resin selected from the group consisting of an olefin-vinyl acetate copolymer and a maleic anhydride-modified polyolefin.

### Olefin-Vinyl Acetate Copolymer

The content of the constituent unit derived from vinyl acetate contained in the olefin-vinyl acetate copolymer as the A1 component is preferably 2 mass % or more, more preferably 4 mass % or more, further preferably 5 mass % or more, and especially preferably 6 mass % or more. Further, the content of the constituent unit derived from vinyl acetate in the olefin-vinyl acetate copolymer as the A1 component is preferably 30 mass % or less, more preferably 25 mass % or less, further preferably 20 mass % or less, and especially preferably 15 mass % or less.

The 2 mass % or more constituent unit derived from vinyl acetate contained in the olefin-vinyl acetate copolymer improves welding strength of the dielectric welding film. Further, the thermoplastic resin as the A1 component can be kept from being excessively tacky at the content of 30 mass % or less of the constituent unit derived from vinyl acetate in the olefin-vinyl acetate copolymer. Consequently, the dielectric welding film can be molded without difficulty.

### Maleic Anhydride-Modified Polyolefin

The maleic anhydride-modified polyolefin as the A1 component preferably has 0.1 mass % or more, more preferably contains 0.2 mass % or more, and further preferably 0.5 mass % or more modification rate by maleic anhydride. The modification rate by maleic anhydride in the A1 component is preferably 30 mass % or less, more preferably 20 mass % or less, and further preferably 10 mass % or less. The modification rate herein refers to a percentage of the mass of the component derived from maleic anhydride to a total mass of the maleic anhydride-modified polyolefin.

The welding strength of the dielectric welding film is improved at 0.1 mass % or more of the modification rate by maleic anhydride in the maleic anhydride-modified polyolefin. The thermoplastic resin as the A1 component can be restrained from being excessively tacky at 30 mass % or less of the modification rate by maleic anhydride in the maleic anhydride-modified polyolefin. Consequently, the dielectric welding film can be molded without difficulty.

The constituent unit derived from olefin in the olefin-vinyl acetate copolymer and the maleic anhydride-modified polyolefin is preferably derived from ethylene or propylene.

Accordingly, the thermoplastic resin as the A component in the first exemplary embodiment preferably contains at least one resin selected from the group consisting of ethylene-vinyl acetate copolymer, propylene-vinyl acetate copolymer, maleic anhydride-modified polyethylene, and maleic anhydride-modified polypropylene.

### Melting Point

The melting point of the A1 component is preferably 50 degrees C. or more, more preferably 60 degrees C. or more, and further preferably 75 degrees C. or more. Meanwhile, the melting point of the A1 component is preferably 200 degrees C. or less, more preferably 190 degrees C. or less, and further preferably 150 degrees C. or less.

Specifically, a crystalline resin as the A1 component, whose melting point (i.e. a temperature at which a crystalline portion is melted) measured by a DSC (Differential Scanning calorimeter) or the like is defined within a predetermined range, can achieve a favorable balance between heat resistance in a use environment and the like and weldability during the dielectric heating.

More specifically, the melting point may be determined using a differential scanning calorimeter by: raising a temperature of 5 mg measurement sample (resin of the A1 component) to 250 degrees C.; cooling the measurement sample to −50 degrees C. at a temperature-decrease rate of 20 degrees C./min to crystallize the measurement sample; again heating the measurement sample at a temperature-increase rate of 20 degrees C./min to re-melt the sample; and measuring a peak temperature of a melting peak observed on a DSC chart (fusion curve) when the sample is re-melted.

At the melting point of the A1 component of 50 degrees C. or more, insufficiency in the heat resistance, excessive limitation on the usage of the dielectric welding film, and significant decrease in the mechanical strength can be prevented.

Meanwhile, at the melting point of the A1 component of 200 degrees C. or less, an excessively long time required for welding through the dielectric heating and excessive decrease in adhesivity can be prevented.

Average Molecular Weight

An average molecular weight (weight average molecular weight) of the resin as the A1 component is usually preferably 5000 or more, more preferably 10000 or more, and further preferably 20000 or more. Meanwhile, the average molecular weight (weight average molecular weight) of the resin as the A1 component is preferably 300000 or less, more preferably 200000 or less, and further preferably 100000 or less.

At the weight average molecular weight of the resin of the A1 component of 5000 or more, significant decrease in the heat resistance and adhesivity can be prevented.

At the weight average molecular weight of the resin of the A1 component of 300000 or less, significant decrease in weldability at the time of dielectric heating can be prevented.

The weight average molecular weight of the A1 component can be measured through, for instance, intrinsic viscosity method according to JIS K 7367-3 (1999).

### Melt Flow Rate

The MFR (Melt Flow Rate) of the resin as the A1 component is usually preferably in a below-described range in a measurement according to JIS K 7210-1 (2014).

The MFR of the resin as the A1 component is preferably 0.5 g/10 min or more, more preferably 1 g/10 min or more, further preferably 2 g/10 min or more as measured under the conditions below. Further, the MFR of the resin as the A1 component is preferably 30 g/10 min or less, more preferably 15 g/10 min or less, further preferably 10 g/10 min or less as measured under the conditions below.

At the MFR of the resin as the A1 component of 0.5 g/10 min or more, the resin can be kept fluid and, consequently, film-thickness accuracy can be easily ensured.

At the MFR of the resin as the A1 component of 30 g/10 min or less, film-formability can be ensured.

It should be noted that the MFR of the resin as the A1 component can be measured at a predetermined test temperature under 2.16 kg load according to JIS K 7210-1 (2014).

The test temperature is determined according to JIS K 7210-1 (2014). For instance, when the constituent unit derived from olefin is polyethylene, the test temperature is 190 degrees C. When the constituent unit derived from olefin is polypropylene, the test temperature is 230 degrees C.

In some examples, the thermoplastic resin as the A component of the dielectric welding film according to the first exemplary embodiment may preferably essentially consist solely of the A1 component. It should be noted that the term “essentially” means that the thermoplastic resin consists solely of the A1 component except for a minute amount of impurities inevitably contained in the thermoplastic resin as the A component.

In some examples, the thermoplastic resin as the A component of the dielectric welding film according to the first exemplary embodiment further contains a thermoplastic resin different from the A1 component. The thermoplastic resin different from the A1 component herein is sometimes referred to as an A2 component.

The type of the thermoplastic resin as the A2 component is not particularly limited.

For instance, in view of meltability and predetermined heat resistance, the thermoplastic resin as the A2 component is preferably at least one resin selected from the group consisting of polyolefin resin, olefin thermoplastic elastomer, styrene thermoplastic elastomer, polyamide resin, polyvinyl acetate resin, polyacetal resin, polycarbonate resin, polyacryl resin, polyamide resin, polyimide resin, polyvinyl acetate resin, phenoxy resin, and polyester resin. The polyester resin is, for instance, crystalline polyester, amorphous polyester, or a mixture of crystalline polyester and amorphous polyester.

The polyolefin resin as the A2 component is preferably a polypropylene resin. With the polypropylene resin, the melting point or softening point of the dielectric welding film can be easily adjusted. Further, polypropylene resin is inexpensive and is excellent in mechanical strength and moldability. It should be noted that permittivity (ϵ/1 MHz) of the polypropylene resin is typically in a range from 2.2 to 2.6, dielectric power factor (tan δ/1 MHz) of the polypropylene resin is in a range from 0.0005 to 0.0018, and loss factor of the polypropylene resin is approximately 0.0047.

The melting point, average molecular weight, and MFR of the thermoplastic resin as the A2 component is preferably in the same range as those of the A1 component.

### Blend Ratio

In the dielectric welding film according to the first exemplary embodiment including the A1 and A2 components, it is preferable that a blend ratio of the A1 component to the A2 component in parts by mass is in a range from 70:30 to 95:5.

When the blend ratio of the A1 component in parts by mass is 70 or more, the blend effect of the A2 component is likely to be achieved while achieving the blend effect of the A1 component, increasing the type of applicable adherends.

Accordingly, the blend ratio of the A1 component in parts by mass is more preferably 80 or more, further preferably 90 or more.

### (2) B Component

### Type

The dielectric filler as the B component preferably generates heat when applied with a high-frequency wave ranging from 1 kHz to 300 MHz. Further, it is preferable that the dielectric filler is a high-frequency-wave-absorbing filler having high dielectric loss factor enough to generate heat when a high-frequency wave of, for instance, 28 MHz or 40 MHz frequency is applied.

The dielectric filler as the B component is preferably a single one of or a combination of two or more of compounds selected from zinc oxide, silicon carbide (SIC), anatase-type titanium oxide, barium titanate, barium zirconate titanate, lead titanate, potassium niobate, rutile-type titanium oxide, hydrated aluminum silicate, inorganic substance having crystallization water such as hydrated aluminosilicate salt of alkali metal, inorganic substance having crystallization water such as hydrated aluminosilicate salt of alkaline earth metal, and the like.

The dielectric filler as the B component is preferably at least one compound selected from the group consisting of zinc oxide and barium titanate.

The dielectric welding film according to the first exemplary embodiment preferably contains at least one of zinc oxide and barium titanate as the B component. The use of at least one of zinc oxide and barium titanate as the B component allows a selection from among wide variety of types of compounds of various shapes and sizes, and improving weldability and mechanical properties of the dielectric welding film depending on intended usage.

The zinc oxide and barium titanate as the dielectric filler can be easily uniformly blended in the A component as the adhesive component (for instance, thermoplastic resin consisting solely of the A1 component or a mixture of the A1 and A2 components). Accordingly, with a relatively small amount of zinc oxide and barium titanate in the dielectric welding film, excellent heat-generating performance can be exhibited in a predetermined dielectric heating as compared with the dielectric welding film blended with the other dielectric filler.

Accordingly, the dielectric welding film containing at least one of zinc oxide and barium titanate as the B component provides excellent weldability in the dielectric heating.

The dielectric welding film according to the first exemplary embodiment preferably does not contain carbon or a carbon compound whose main component is carbon (e.g. carbon black), and conductive material such as metal. More specifically, the content of the conductive material is preferably 5 mass % or less, more preferably 0 mass % of a total mass of the dielectric welding film. At the content of 5 mass % or less of the conductive material in the dielectric welding film, carbonization on a welded portion and adherend, which is caused by electrical insulation breakdown at the time of dielectric heating, can be prevented.

### Content Ratio

The content of the B component in the dielectric welding film ranges from 3 volume % to 40 volume %. The content of the B component in the dielectric welding film is preferably 5 volume % or more, more preferably 13 volume % or more. Further, the content of the B component in the dielectric welding film is preferably 35 volume % or less, more preferably 25 volume % or less.

At the content ratio of the B component of 3 volume % or more, sufficient heat can be generated at the time of dielectric heating. Consequently, excessive reduction in meltability of the thermoplastic resin as the A component, which results in failure in achieving tight adhesion, can be prevented.

At the content ratio of the B component of 40 volume % or less, decrease in the fluidity of the dielectric welding film at the time of dielectric heating, and electric conduction between electrodes at the time of applying the high-frequency wave can be prevented. Further, at the content ratio of the B component of 40 volume % or less, decrease in film-formability, flexibility, and toughness can be prevented.

In the dielectric welding film containing the A and B components according to the first exemplary embodiment, the content of the B component with respect to a total volume of the A and B components is preferably 3 volume % or more, more preferably 5 volume % or more, further preferably 13 volume % or more. Further, the content of the B component with respect to the total volume of the A and B components is preferably 40 volume % or less, more preferably 35 volume % or less, further preferably 25 volume % or less.

### Mean Particle Size

The mean particle size (median diameter, D50) of the dielectric filler as the B component is preferably 0.1 μm or more, more preferably 1 μm or more, further preferably 2 μm or more, furthermore preferably 3 μm or more. The mean particle size (median diameter, D50) of the dielectric filler as the B component is preferably 30 μm or less, more preferably 25 μm or less, further preferably 20 μm or less. The mean particle size (median diameter, D50) of the B component is a value measured according to JIS Z 8819-2 (2001).

At an excessively small mean particle size of the B component, inversion motion caused when a high-frequency wave is applied is attenuated to cause excessive decrease in the dielectric weldability, sometimes making it difficult to achieve tight adhesion between adherends.

Meanwhile, as the mean particle size of the B component increases, a polarizable distance in the filler increases. As a result, the filler is more polarized and the inversion motion caused when a high-frequency wave is applied is intensified, thereby improving the dielectric weldability.

Accordingly, when the mean particle size of the dielectric filler as the B component is 0.1 μm or more, the polarizable distance inside the filler is not excessively reduced and the decrease in the polarization degree can be prevented, though depending on the type of the filler.

When the mean particle size of the B component is excessively large, the distance between neighboring dielectric fillers becomes short and the inversion motion caused when a high-frequency wave is applied is attenuated due to electric charge of the neighboring dielectric fillers, so that the dielectric weldability may be excessively reduced and the adherends may be less tightly welded.

The mean particle size of the B component of 30 μm or less can prevent excessive decrease in dielectric weldability and avoid difficulty in achieving tight welding between the adherends.

When the dielectric filler as the B component is zinc oxide, the mean particle size of the B component is preferably in a range from 10 μm to 20 μm.

It should be noted that the mean particle size of the B component is preferably smaller than the thickness of the dielectric welding film.

### (3) Additive

The dielectric welding film according to the first exemplary embodiment optionally contains an additive(s).

Examples of the additive capable of being contained in the dielectric welding film of the first exemplary embodiment include tackifier, plasticizer, wax, coloring agent, antioxidant, ultraviolet absorber, antibacterial agent, coupling agent, viscosity modifier, organic filler, and inorganic filler. The organic filler and inorganic filler as the additive are different from the dielectric filler as the B component.

The tackifier and the plasticizer can improve melting and welding properties of the dielectric welding film.

Examples of the tackifier include rosin derivative, polyterpene resin, aromatic modified terpene resin, hydrogenated products of aromatic modified terpene resin, terpene phenol resin, coumarone⋅indene resin, aliphatic petroleum resin, aromatic petroleum resin, and hydrogenated products of aromatic petroleum resin.

Examples of the plasticizer include petroleum process oil, natural oil, diacid dialkyl, and low-molecular-weight liquid polymer. Examples of the petroleum process oil include paraffin process oil, naphthene process oil, and aromatic process oil. Examples of the natural oil include castor oil and tall oil. Examples of the diacid dialkyl include dibutyl phthalate, dioctyl phthalate, and dibutyl adipate. Examples of the low-molecular liquid polymer include liquid polybutene and liquid polyisoprene.

When the dielectric welding film according to the first exemplary embodiment contains the additive(s), the content of the additive(s) in the dielectric welding film is usually preferably 0.01 mass % or more, more preferably 0.05 mass % or more, further preferably 0.1 mass % or more of the total mass of the dielectric welding film. The content of the additive(s) in the dielectric welding film is preferably 20 mass % or less, more preferably 15 mass % or less, further preferably 10 mass % or less of the total mass of the dielectric welding film.

The dielectric welding film of the first exemplary embodiment is producible by: preliminarily blending the above components; kneading the components using an extruder or a known kneader such as a heat roller; and molding the components through known molding process such as extrusion molding, calender molding, injection molding, and casting.

### 2 Properties of Dielectric Welding Film

### (1) Thickness

The thickness of the dielectric welding film is usually preferably 10 μm or more, more preferably 50 μm or more, further preferably 100 μm or more. Further, the thickness of the dielectric welding film is preferably 2000 μm or less, more preferably 1000 μm or less, further preferably 600 μm or less.

At the thickness of the dielectric welding film of 10 μm or more, rapid decrease in the adhesivity between the adherends can be prevented. Further, when the thickness of the dielectric welding film is 10 μm or more, the dielectric welding film can conform to irregularities possibly present on a welding surface of the adherends, allowing the welding strength to be more readily exhibited.

When the thickness of the dielectric welding film is 2000 μm or less, the dielectric welding film, which is embodied as a long object, can be wound into a roll and can be applied to a roll-to-roll process. Further, the dielectric welding film can be easily handled in a subsequent step such as punching. The weight of the entirety of welded product increases with an increase in the thickness of the dielectric welding film. Accordingly, the thickness of the dielectric welding film is preferably set within a range not causing a problem in use.

### (2) Dielectric Property (tan δ/ϵ′)

The dissipation factor (tan δ) and permittivity (ϵ′) as the dielectric properties of the dielectric welding film, which may be measured according to JIS C 2138:2007, can be easily and accurately measured in accordance with impedance material method.

The dielectric property (tan δ/ϵ′) of the dielectric welding film is preferably 0.005 or more, more preferably 0.008 or more, further preferably 0.01 or more. Further, the dielectric property (tan δ/ϵ′) of the dielectric welding film is preferably 0.05 or less, more preferably 0.03 or less. The dielectric property (tan δ/ϵ′) is a value obtained by dividing the dissipation factor (tan δ) measured with an impedance/material analyzer or the like by permittivity (ϵ′) measured with an impedance/material analyzer or the like.

The dielectric property of 0.005 or more can prevent the dielectric welding film from failing to generate heat as desired to make it difficult to tightly adhere the adherends at the time of dielectric heating.

However, excessively large dielectric property of the dielectric welding film is likely to damage the adherends.

The details of the measurement method of the dielectric property of the dielectric welding film are as follows. With an impedance/material analyzer E4991 (manufactured by Agilent Technologies, Inc.), the permittivity (ϵ′) and dissipation factor (tan δ) of the dielectric welding film cut into the predetermined size are measured at 23 degrees C. and 40 MHz frequency to calculate the value of the dielectric property (tan δ/ϵ′).

### (3) Melt Flow Rate

The MFR (Melt Flow Rate) of the dielectric welding film is usually preferably in a below-described range in a measurement according to JIS K 7210-1 (2014).

The MFR of the dielectric welding film is preferably 0.5 g/10 min or more, more preferably 1 g/10 min or more, further preferably 2 g/10 min or more as measured under the conditions below. Further, the MFR of the dielectric welding film is preferably 30 g/10 min or less, more preferably 15 g/10 min or less, further preferably 10 g/10 min or less as measured under the conditions below.

At the MFR of the dielectric welding film of 0.5 g/10 min or more, fluidity can be maintained and, consequently, thickness accuracy can be easily ensured.

At the MFR of the dielectric welding film of 30 g/10 min or less, film-formability can be ensured.

It should be noted that the MFR of the dielectric welding film can be measured at a predetermined test temperature under 2.16 kg load according to JIS K 7210-1 (2014).

The test temperature is determined according to JIS K 7210-1 (2014). For instance, when the constituent unit derived from olefin is polyethylene, the test temperature is 190 degrees C. When the constituent unit derived from olefin is polypropylene, the test temperature is 230 degrees C.

The dielectric welding film according to the first exemplary embodiment can reduce the application time of high-frequency wave and can improve the welding strength even at a short application time of the high-frequency wave.

The dielectric welding film according to the first exemplary embodiment exhibits favorable weldability to an adherend made of a polyolefin resin. Further, the dielectric welding film according to the first exemplary embodiment is applicable to various adherends made of high-function thermoplastic resins such as FRP (Fiber-Reinforced Plastic), ABS resin, and PC resin, which are expected to be more widely used in the future. Accordingly, the dielectric welding film according to the first exemplary embodiment is usable in a bonding technique for bonding FRP (Fiber-Reinforced Plastic) in the fields of airplane and automobile whose weight is increasingly reduced, and for bonding components of electronics and medical equipment whose size is increasingly reduced and structure is increasingly complicated.

Further, the thickness and the like of dielectric welding film according to the first exemplary embodiment can be controlled as necessary. Accordingly, the dielectric welding film according to the first exemplary embodiment is applicable to a roll-to-roll process. Further, the dielectric welding film according to the first exemplary embodiment can be designed into any size and shape by punching or the like depending on the adhesion area and shape between the plurality of adherends. Thus, the dielectric welding film according to the first exemplary embodiment is advantageous in terms of the benefit in production process.

### Second Exemplary Embodiment

In a second exemplary embodiment, a welding method using a dielectric welding film for welding adherends of the same material or different materials though dielectric heating will be described.

The dielectric welding film used in the welding method according to the second exemplary embodiment contains an A component in a form of a thermoplastic resin and a B component in a form of a dielectric filler, the A component including a polyolefin resin having a polar part, a content of the B component in the dielectric welding film ranging from 3 volume % to 40 volume %. The dielectric method includes the following steps (1) and (2).
(1) Holding the dielectric welding film between a plurality of adherends
(2) Applying dielectric heating on the dielectric welding film held between the plurality of adherends with a dielectric heater at a high-frequency output ranging from 0.01 to 20 kW for a high-frequency-wave application time of 1 second or more and less than 40 seconds

The various dielectric welding films according to the first exemplary embodiment are usable in the welding method according to the second exemplary embodiment.

The welding method of the dielectric welding film according to the second exemplary embodiment will be described below mainly on features different from those in the first exemplary embodiment.

### 1. Step (1)

In Step (1), the dielectric welding film is placed at a predetermined position. Specifically, the dielectric welding film is held between a plurality of adherends of the same material or different materials in Step (1).

At this time, it is usually preferable to hold the dielectric welding film between the plurality of adherends after the dielectric welding film is cut into pieces of a predetermined shape.

The dielectric welding film may include an adhering portion. The presence of the adhering portion allows the dielectric welding film to be disposed at an accurate position without misalignment when being held between a plurality of adherends. The adhering portion may be provided on one side or on both sides of the dielectric welding film. The adhering portion may be provided entirely or partially over a surface of the dielectric welding film.

A temporarily-fixing hole and/or projection may be provided at a part of the dielectric welding film. The presence of the temporarily-fixing hole and/or projection allows the dielectric welding film to be disposed at an accurate position without misalignment when being held between the plurality of adherends.

The material of the adherend usable in the welding method of the dielectric welding film according to the second exemplary embodiment is not particularly limited. The material usable for the adherends may be any one of an organic material, an inorganic material (including metal material) or a composite of the organic and inorganic materials.

The number of the adherends usable in the welding method of the dielectric welding film according to the second exemplary embodiment is only necessary to be plural and not particularly limited otherwise. According to the welding method of the second exemplary embodiment, for instance, a pair of (i.e. two) adherends (a first adherend and a second adherend) are weldable. Alternatively, three or more adherends may be welded according to the welding method of the second exemplary embodiment. For instance, when three adherends (a first adherend, a second adherend, and a third adherend) are to be welded, the second and third adherends may be juxtaposed facing the first adherend, where first and second dielectric welding films may be held between the first adherend and the second adherend and between the first adherend and the third adherend, respectively. Alternatively, a single dielectric welding film may be disposed over the second and third adherends and held between the first adherend and the second and third adherends. In welding the plurality of adherends, for instance, a single adherend may be bent and welded. In this case, the plurality of adherends correspond to a first portion of the adherend and a second portion of the adherend that is different from the first portion and overlapped over the first portion.

The plurality of adherends used in the welding method according to the second exemplary embodiment are made of the same material or different materials.

Examples of the organic material include a plastic material and a rubber material. Examples of the plastic material include polypropylene resin, polyethylene resin, polyurethane resin, acrylonitrile-butadiene-styrene copolymer resin (ABS resin), polycarbonate resin (PC resin), polyamide resin (e.g. Nylon 6, Nylon 66), polyester resin (e.g. polybutylene terephthalate resin (PBT resin)), polyacetal resin (POM resin), polymethyl methacrylate resin and polystyrene resin. Examples of the rubber material include styrene-butadiene rubber (SBR), ethylene propylene rubber (EPR) and silicone rubber. The adherend may be a foam of the organic material.

Examples of the inorganic material include a glass material, cement material, ceramic material, and a metal material. Alternatively, the inorganic material may preferably be FRP (Fiber Reinforced Plastics), which is a composite material of glass fiber and the above-described plastic material.

Especially, when the material of the adherend is polypropylene, polyethylene or the like, whose adherend surface is of low polarity, the adherend is hard-to-bond. The dielectric welding method according to the second exemplary embodiment can improve the welding strength even when the adherend is made of polypropylene, polyethylene or the like.

### 2. Step (2)

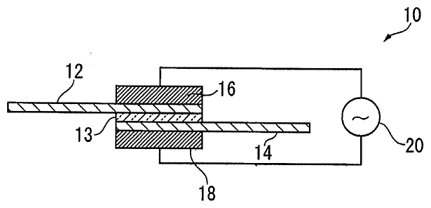

In the step (2), dielectric heating is applied on the dielectric welding film held between the plurality of adherends with a dielectric welding machine as shown in FIG. 1, for instance, at a high-frequency output ranging from 0.01 to 20 kW and a high-frequency wave application time of 1 second or more and less than 40 seconds.

The dielectric welding machine used in the step (2) and dielectric heating conditions thereof will be described below.

### (1) Dielectric Welding Machine

FIG. 1 is a schematic illustration of a dielectric welding machine 10.

The dielectric welding machine 10 includes a first high-frequency electrode 16, a second high-frequency electrode 18, and a high-frequency power source 20.

The first high-frequency electrode 16 and the second high-frequency electrode 18 are disposed to face each other. The first high-frequency electrode 16 and the second high-frequency electrode 18 include a press mechanism configured to apply pressure to the first adherend 12, the second adherend 14, and the dielectric welding film 13 between the electrodes.

The high-frequency power source 20 is configured to apply a high-frequency wave of, for instance, approximately 28 MHz or 40 MHz frequency to each of the first high-frequency electrode 16 and second high-frequency electrode 18.

As shown in FIG. 1, the dielectric welding machine 10 is configured to apply dielectric heating through the dielectric welding film 13 interposed between the first adherend 12 and the second adherend 14. Further, the dielectric welding machine 10 is configured to apply pressure by the first high-frequency electrode 16 and/or the second high-frequency electrode 18 to weld the first adherend 12 and the second adherend 14.

When a high-frequency electric field is created between the first and second high-frequency electrodes 16, 18, high-frequency wave energy is absorbed by the dielectric filler (not shown) uniformly dispersed in the adhesive component in the dielectric welding film 13 at a part at which the first adherend 12 and the second adherend 14 are overlapped.

The dielectric filler (B component) serves as a heat source, the heat generated by the dielectric filler melting the thermoplastic resin component(s) (A component) in the dielectric welding film 13, thereby eventually tightly welding the first adherend 12 and the second adherend 14 even within a short time.

Subsequently, compression force is applied by the first high-frequency electrode 16 and the second high-frequency electrode 18 serving also as a press machine as shown in FIG. 1. The melting of the dielectric welding film 13 in combination with the compression force applied by the electrodes 16 and 18 achieves tight welding of the first adherend 12 and the second adherend 14.

### (2) Dielectric Heating Conditions

The dielectric heating conditions may be changed as necessary. The high-frequency output is usually preferably 0.01 kW or more, more preferably 0.05 kW or more, further preferably 0.1 kW or more. The high-frequency output is preferably 20 kW or less, more preferably 15 kW or less, further preferably 10 kW or less.

The application time of the high-frequency wave is preferably 1 second or more. Further, the application time of the high-frequency wave is preferably less than 40 seconds, more preferably 20 seconds or less, further preferably 10 seconds or less.

The frequency of the high-frequency wave is preferably 1 kHz or higher, more preferably 1 MHz or higher, further preferably 5 MHz or higher, and furthermore preferably 10 MHz or higher. The frequency of the high-frequency wave is preferably 300 MHz or lower, more preferably 100 MHz or lower, further preferably 80 MHz or lower, and furthermore preferably 50 MHz or lower. Specifically, 13.56 MHz, 27.12 MHz, or 40.68 MHz of ISM band allocated by the International Telecommunication Union is used in the dielectric welding method according to the second exemplary embodiment.

The welding method using the dielectric welding film according to the second exemplary embodiment can reduce the application time of the high-frequency wave and can improve the welding strength even at a short application time of the high-frequency wave.

The welding method using the dielectric welding film according to the second exemplary embodiment can selectively and locally heat a predetermined part from an outside with the dielectric heater. Accordingly, the welding method using the dielectric welding film according to the second exemplary embodiment is very effective in welding adherends of a large-sized and complicated three-dimensional structure or a thick complicated three-dimensional structure with high dimensional accuracy.

### Modification(s)

The scope of the invention is not limited to the above exemplary embodiments, but includes modifications and improvements as long as the modifications and improvements are compatible with an object of the invention.

### EXAMPLES

The invention will be described in more detail below with reference to Examples. It should be noted that the scope of the invention is by no means limited by Examples.

### Preparation of Dielectric Welding Film

### Example 1

80.0 volume % of ethylene-vinyl acetate copolymer (Ultracene 510 manufactured by TOSOH CORPORATION, melting point: 101 degrees C., referred to as A1-1 in Table 1) as the (A) component, and 20.0 volume % of zinc oxide (LPZINC11 manufactured by Sakai Chemical Industry Co., Ltd., mean particle size: 11 μm, referred to as B-1 in Table 1) as the B component were each weighed in a vessel. Contents of the components are shown in Table 1. The blend ratio of each components in Table 1 is shown in volume %.

The weighed A and B components were preliminarily mixed in a vessel. After the components were preliminarily mixed, the A and B components were fed into a hopper of a 30-mm-diameter biaxial extruder, where the components were melted and kneaded at a cylinder set temperature in a range from 180 to 200 degrees C. and a die temperature of 200 degrees C. Subsequently, the melted and kneaded components were water-cooled and pelletized by a pelletizer to obtain granular pellets.

Then, the obtained granular pellets were put into a hopper of a uniaxial extruder provided with a T-die, and a film-shaped molten kneaded product was extruded from the T-die at a cylinder temperature of 200 degrees C. and a die temperature of 200 degrees C., and cooled by a cooling roller to obtain a 400-μm thick dielectric welding film.

### Example 2

In Example 2, a dielectric welding film was prepared in the same manner as in Example 1 except that the A component was changed to an ethylene-vinyl acetate copolymer (Evaflex EV560, manufactured by DOW-MITSUI POLYCHEMICALS, melting point: 88.8 degrees C., referred to as A1-2 in Table 1).

### Example 3

In Example 3, a dielectric welding film was prepared in the same manner as in Example 1 except that the A component was changed to an ethylene-vinyl acetate copolymer (Evaflex EV260, manufactured by DOW-MITSUI POLYCHEMICALS, melting point: 69.4 degrees C., referred to as A1-3 in Table 1).

### Example 4

In Example 4, a dielectric welding film was prepared in the same manner as in Example 2 except that the ratio of (A1-2) ethylene-vinyl acetate copolymer as the A component was 95.0 volume %, and the ratio of (B-1) zinc oxide as the B component was 5.0 volume %.

### Example 5

In Example 5, a dielectric welding film was prepared in the same manner as in Example 2 except that the ratio of (A1-2) ethylene-vinyl acetate copolymer as the A component was 70.0 volume %, and the ratio of (B-1) zinc oxide as the B component was 30.0 volume %.

### Example 6

In Example 6, a dielectric welding film was prepared in the same manner as in Example 2 except that the B component was changed to barium titanate (BT02, manufactured by Sakai Chemical Industry Co., Ltd., mean particle size: 0.2 μm, referred to as B-2 in Table 1).

### Example 7

In Example 7, a dielectric welding film was prepared in the same manner as in Example 1 except that the A component was changed to a maleic anhydride-modified polyethylene (MODIC M545, manufactured by Mitsubishi Chemical Corporation, melting point: 104 degrees C., referred to as A1-4 in Table 1).

### Example 8

In Example 8, a dielectric welding film was prepared in the same manner as in Example 1 except that the A component was changed to a maleic anhydride-modified polypropylene (MODIC P565, manufactured by Mitsubishi Chemical Corporation, melting point: 108 degrees C., referred to as A1-5 in Table 1).

### Comparative 1

In Comparative 1, a dielectric welding film was prepared in the same manner as in Example 1 except that the A component was changed to a low-density polyethylene (SUMIKATHENE L705, manufactured by Sumitomo Chemical Co., Ltd., referred to as A2 in Table 1).

### Comparative 2

In Comparative 2, a dielectric welding film was prepared in the same manner as in Example 1 except that the ratio of (A1-1) ethylene-vinyl acetate copolymer as the A component was 100 volume %, and the B component was not added.

### Application Time Required for Welding

Prepared dielectric welding films were each cut into 25 mm×12.5 mm pieces. With the cut dielectric welding film pieces being held between a pair of glass-fiber reinforced polypropylene plates (25 mm×100 mm×1.5 mm) as the adherends and subsequently being fixed between electrodes of a high-frequency wave dielectric heater (YRP-400t-A manufactured by YAMAMOTO VINITA CO., LTD), a high-frequency wave at a frequency of 40 MHz and output of 0.2 kW was applied for 2, 3, 4, 5, 6, 7, 8, 9, and 10 seconds to prepare evaluation samples. With a universal tensile tester (Instron 5581 manufactured by Instron Corporation), each of the prepared test pieces was pulled until being ruptured at a tension rate of 100 mm/min, and the ruptured face was visually checked. The application time (seconds) of the high-frequency wave for causing material rupture or cohesive failure is shown in Table 1. A sample that caused material rupture or cohesive failure in 10 seconds or less of application time is determined to be acceptable. The sign “>10” in Table 1 indicates that the material rupture or cohesive failure was not caused even after 10 seconds application time.

Welding Strength after 10-Second Application Time

Prepared dielectric welding films were each cut into 25 mm×12.5 mm pieces. With the cut dielectric welding film pieces being held between a pair of glass-fiber reinforced polypropylene plates (25 mm×100 mm×1.5 mm) as the adherends and subsequently being fixed between electrodes of a high-frequency wave dielectric heater (YRP-400t-A manufactured by YAMAMOTO VINITA CO., LTD), a high-frequency wave at a frequency of 40 MHz and output of 0.2 kW was applied for 10 seconds. With a universal tensile tester (Instron 5581 manufactured by Instron Corporation), a tensile shear force of the test piece obtained in the evaluation of high-frequency weldability” was measured at a tension rate of 100 mm/min, and was observed in terms of tensile shear force. Welding strength of 4 MPa or more was determined to be acceptable. The tensile shear force was measured according to JIS K6850 (1999).

### Melt Flow Rate

The MFR was measured according to JIS K 7210-1 (2014) at a test temperature of 190 degrees C. or 230 degrees C. under 2.16 kg load.

### Dielectric Filler Particle Size (Mean Particle Size)

The particle size of the dielectric filler was measured according to JIS Z 8819-2 (2001).

### Dielectric Property

Prepared dielectric welding films were each cut into 30 mm×30 mm pieces. With an impedance/material analyzer E4991 (manufactured by Agilent Technologies, Inc.), the permittivity (ϵ′) and dissipation factor (tan δ) of the cut welding film were measured at 23 degrees C. and 40 MHz frequency. The value of the dielectric property (tan δ/ϵ′) was calculated based on the results of the measurement.

TABLE 1

| | Content | | | | | | | | | weld test | |
|---|---|---|---|---|---|---|---|---|---|---|---|
| | (unit: [volume %]) | | | | | | | | | application | |
| | Thermoplastic resin | | | | | | | | | time for | welding |
| | (A component) | | | | | | | | | causing | strength |
| | | | | maleic | maleic | | Dielectric filler | | | material | after 10- |
| | | | | anhydride- | anhydride- | | (B component) | | die- | rupture or | second |
| | ethylene-vinyl | | | modified | modified | low-density | zinc | barium | lectric | cohesive | application |
| | acetate copolymer | | | polyethylene | polypropylene | polyethylene | oxide | titanate | property | failure | time |
| Composition | A1-1 | A1-2 | A1-3 | A1-4 | A1-5 | A2 | B-1 | B-2 | [—] | [sec.] | [MPa] |

| | | | | | | | | | |
|---|---|---|---|---|---|---|---|---|---|
| Copolymer- | [mass %] | 6 | 14 | 28 | — | — | 0 | — | — |
| ization | | | | | | | | | |
| rate or | | | | | | | | | |
| modification | | | | | | | | | |
| rate | | | | | | | | | |
| density | [g/cm³] | 0.93 | 0.93 | 0.95 | 0.90 | 0.89 | 0.92 | 5.31 | 6.02 |
| MFR* | [g/10 min] | 2.5 | 3.5 | 6.0 | 6.0 | 5.7 (230° C.) | 7.0 | — | — |
| particle size | [μm] | — | — | — | — | — | — | 11 | 0.2 |

| | | | | | | | | | | | |
|---|---|---|---|---|---|---|---|---|---|---|---|
| Example 1 | 80.0 | — | — | — | — | — | 20.0 | — | 0.015 | 5 | 5.1 |
| Example 2 | — | 80.0 | — | — | — | — | 20.0 | — | 0.019 | 5 | 6.6 |
| Example 3 | — | — | 80.0 | — | — | — | 20.0 | — | 0.020 | 5 | 5.3 |
| Example 4 | — | 95.0 | — | — | — | — | 5.0 | — | 0.010 | 5 | 5.6 |
| Example 5 | — | 70.0 | — | — | — | — | 30.0 | — | 0.023 | 3 | 7.2 |
| Example 6 | — | 80.0 | — | — | — | — | — | 20.0 | 0.011 | 5 | 6.4 |
| Example 7 | — | — | — | 80.0 | — | — | 20.0 | — | 0.012 | 7 | 5.2 |
| Example 8 | — | — | — | — | 80.0 | — | 20.0 | — | 0.013 | 7 | 6.7 |
| Comparative 1 | — | — | — | — | — | 80.0 | 20.0 | — | 0.011 | 10 | 3.2 |
| Comparative 2 | — | — | 100 | — | — | — | — | — | 0.014 | >10 | 2.2 |

*test temperature 190° C., temperature in parentheses represents test temperature under different measurement conditions.

As shown in Table 1, the dielectric welding films according to Examples 1 to 8, which contained the polyolefin resin (A1 component) having predetermined polar parts and the dielectric filler (B component, at a predetermined content ranging from 3 volume % to 40 volume % in the dielectric welding film), were acceptable in terms of the evaluation items regarding the application time required for welding, and welding strength.

In contrast, the dielectric welding film according to Comparative 1, whose thermoplastic resin was a low-density polyethylene and had no predetermined polar parts, was not acceptable in terms of welding strength. The dielectric welding film according to Comparative 2, which contained ethylene-vinyl acetate copolymer as the thermoplastic resin but did not contain the dielectric filler (B component), was not acceptable in terms of the application time required for welding, and the welding strength.

As described above, a dielectric welding film containing the thermoplastic resin with predetermined polar parts (A1 component) and the dielectric filler (B component) is found effective for a component for welding a plurality of adherends of the same material or different materials through dielectric heating.

### EXPLANATION OF CODES

10: dielectric welding machine
12: first adherend
13: dielectric welding film
14: second adherend
16: first high-frequency electrode (also serving as a part of a press machine)
18: second high-frequency electrode (also serving as a part of a press machine)
20: high-frequency power source

1. A dielectric welding film configured to weld a plurality of adherends of the same material or different materials though dielectric heating, the dielectric welding film comprising:
a thermoplastic resin as an A component; and
a dielectric filler as a B component, wherein
the A component comprises a polyolefin resin having a polar part,
a content of the B component in the dielectric welding film ranges from 3 volume % to 40 volume %, and
a dielectric property (tan δ/ϵ′), which is calculated based on a dissipation factor tan δ and permittivity ϵ′ of the dielectric welding film measured at 23 degrees C. and 40 MHz frequency, is 0.005 or more.

2. The dielectric welding film according to claim 1, wherein
the B component is at least one compound selected from the group consisting of zinc oxide, silicon carbide (SiC), and anatase-type titanium oxide.

3. The dielectric welding film according to claim 1, wherein
the B component generates heat when applied with a high-frequency wave ranging from 1 kHz to 300 MHz.

4. The dielectric welding film according to claim 1, wherein
a mean particle size of the dielectric filler as the B component measured according to JIS Z 8819-2 (2001) is in a range from 0.1 μm to 30 μm.

5. The dielectric welding film according to claim 1, wherein
a constituent unit derived from olefin in the A component is derived from ethylene or propylene.

6. The dielectric welding film according to claim 1, wherein
the polar part is a carboxy group, or an acid anhydride moiety.

7. A welding method using a dielectric welding film configured to weld a plurality of adherends of the same material or different materials though dielectric heating, the dielectric welding film being the dielectric welding film according to claim 1, the method comprising:
holding the dielectric welding film between the plurality of adherends; and
applying the dielectric heating on the dielectric welding film held between the plurality of adherends with a dielectric heater at a high-frequency output ranging from 0.01 to 20 kW for a high-frequency-wave application time ranging from 1 second to 40 seconds.

8. The welding method using the dielectric welding film according to claim 7, wherein
a frequency of the high-frequency wave applied in applying the dielectric heating ranges from 1 kHz to 300 MHz.

9. The dielectric welding film according to claim 2, wherein
the B component is zinc oxide.

10. The welding method using the dielectric welding film according to claim 7, wherein
the B component is at least one compound selected from the group consisting of zinc oxide, silicon carbide (SiC), and anatase-type titanium oxide.
